(19) United States
(12) Patent Application Publication
(10) Pub. No.: US 2005/0028604 A1
(43) Pub. Date: Feb. 10, 2005

(54) Sensor system for monitoring load displacements in a freight vehicle

(76) Inventors: Fathi Saigh, Dollard-des-Ormeaux (CA); Richard Chartrand, Chateauguay (CA)

Correspondence Address: OGILVY RENAULT, 1981 MCGILL COLLEGE AVENUE, SUITE 1600, MONTREAL, QC, H3A2Y3, CA

(21) Appl. No.: 10/909,383

(22) Filed: Aug. 3, 2004

Related U.S. Application Data
(60) Provisional application No. 60/491,967, filed on Aug. 4, 2003.

(51) Int. Cl. B60P 3/00

(52) U.S. Cl. 73/760

(57) ABSTRACT

A system for monitoring a load for displacement on a vehicle, comprising a support structure adapted to be fixed to the vehicle. A sensor is supported by the support structure. The sensor is positioned with respect to the load so as to detect a displacement of the load with respect to the vehicle. An interface receives and processes signals from the sensor and to a user of the vehicle.

### CROSS-REFERENCE TO RELATED APPLICATION

This patent application claims priority on U.S. Provisional Patent Application No. 60/491,967, filed on Aug. 4, 2003, by the present Applicants.

### TECHNICAL FIELD

The present invention generally relates to the freight industry and, more particularly, to a sensor system for monitoring load displacements in freight vehicles.

### BACKGROUND ART

In the freight industry, loads are transported using various types of vehicles: trucks, trains, boats and planes. Loads carried by such vehicles are subjected to displacement forces to a varying extent as a function of these vehicles. Factors such as the nature of the transportation (airborne, on rails, on a road, on water), the velocity of the vehicles, braking and accelerating forces, gravity, each have an effect on the displacement forces on the loads within the vehicles. As an example, the road transport vehicles represent the most versatile solution amongst these vehicles for terrestrial transportation. These vehicles may have a load carrying surface or container as an integral part thereof, or as a detachable part, such as a trailer. The trailer may take the form of a container (e.g., van) or of an exposed surface (e.g., flat bed).

A disadvantage of the road transport vehicle over the other types of vehicles is related to the versatility of the road vehicle. As it travels on the roads, the road vehicle performs sharp movements when compared to the other freight vehicles. For instance, the road vehicle must perform sharper turns and more abrupt stops than the other freight vehicles. Moreover, the road vehicle is subjected to the road conditions, including defects in the surfacing of the road, type of pavement (e.g., gravel or dirt road), weather conditions (e.g., presence of ice on the road), and slopes.

Accordingly, loads carried by freight trucks are subjected to displacements because of the road conditions and/or sharp movements of the vehicles. Also, the nature of the load may cause some inconvenience with regards to its transportation. For example, pipes are strapped onto a flat bed, piled up on one another. Such loads frequently move during transportation as a result from the shocks sustained.

A load displacement results in a change in the weight distribution of the freight vehicle. This change in weight distribution has an effect on the maneuverability of the vehicle, and this may ultimately result in severe consequences. Freight trucks with an uneven weight distribution represent a road hazard. The unequal weight distribution caused by movement of the load may result in truck roll-over, or in the loads falling off the truck in open-air transport. In the latter case, the fallen loads represent a danger for the surrounding vehicles.

### SUMMARY OF INVENTION

Therefore, it is a feature of the present invention to provide a sensor system for monitoring load displacement of freight vehicles.

It is a further feature of the present invention that the load monitoring sensor system provide displacement orientation and magnitude.

Therefore, in accordance with the present invention, there is provided a sensor for detecting displacement of a load in a freight vehicle, comprising a fixed portion adapted to be secured to the freight vehicle in a given position, with respect to the load, a movable portion adapted to be releasably connected to the load so as to be displaced by displacements of the load, a joint interconnecting the fixed portion to the movable portion so as to allow relative motion between the fixed portion and the movable portion, and a signal generator connected to any of the fixed portion, the movable portion and the joint so as to detect relative motion between the fixed portion and the movable portion so as to signal a displacement of the load.

Further in accordance with the present invention, there is provided a method for signaling a displacement of a load in a freight vehicle, comprising the steps of providing a sensor positioned with respect to the load such that the sensor is triggered by a displacement of the load with respect to the freight vehicle, obtaining a signal from the sensor for the displacement, and sending the signal to a driver of the freight vehicle to indicate that the load has been subjected to a displacement.

### BRIEF DESCRIPTION OF DRAWINGS

A preferred embodiment of the present invention will now be described with reference to the accompanying drawings in which:

FIG. 1 is a schematic view, partly sectioned, of a sensor for monitoring load displacements, constructed in accordance with a preferred embodiment of the present invention; and

FIG. 2 is a block diagram of a sensor system for monitoring load displacements, constructed in accordance with a preferred embodiment of the present invention.

### DESCRIPTION OF PREFERRED EMBODIMENTS

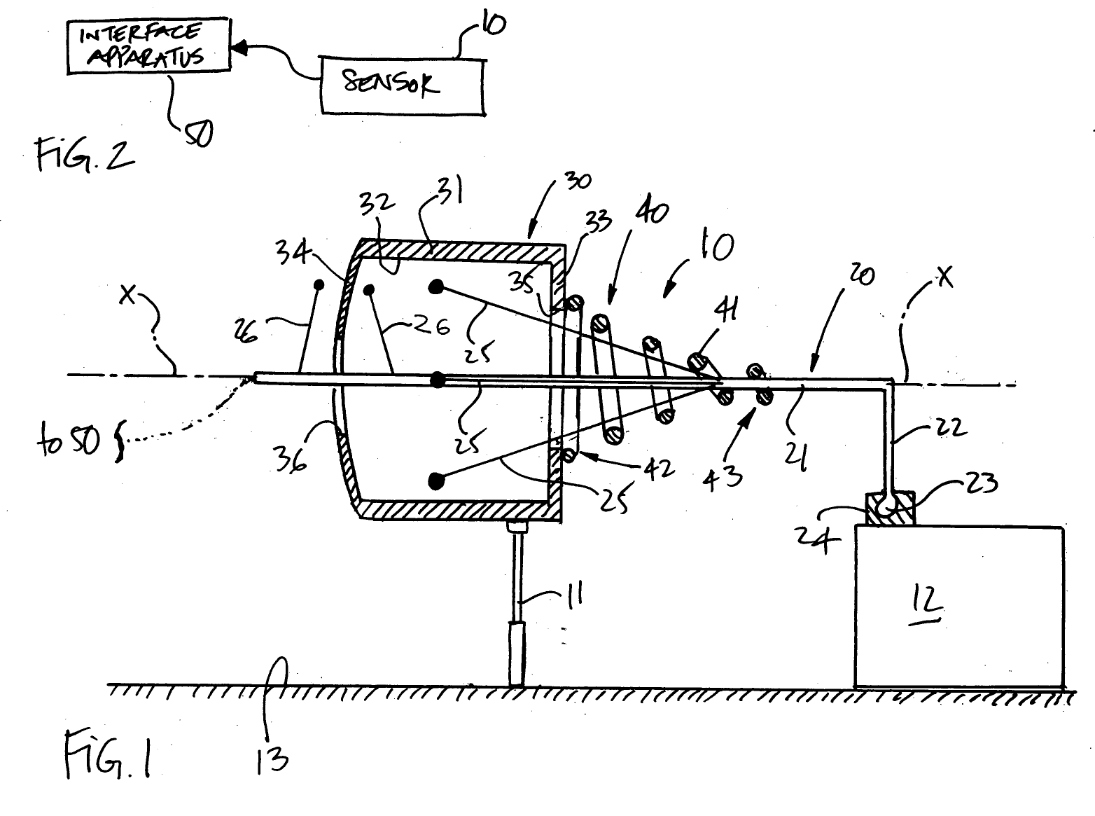

Referring to the drawings and, more particularly, to FIG. 1, a sensor for monitoring load displacements is generally shown at 10. The sensor 10 is supported in a desired position by a support structure 11. The support structure 11 is preferably positioned in the load carrying portion of the vehicle, adjacent to a load 12. For instance, the support structure 11 is fixed to a support surface 13 of the vehicle, and is thus the fixed portion of the sensor 10.

The support structure 11 may be provided with various configurations to enable the position and orientation adjustment of the sensor 10 with respect to the load 12. For example, the support structure 11 has a telescopic mechanism for the adjustment of the vertical position of the sensor 10, and to be pivotable about a longitudinal axis of the telescopic mechanism. The sensor 10 has a sensor arm 20, a receptacle 30 secured to the support structure 11 to form the fixed portion, and a joint member 40 operatively connecting the sensor arm 20 to the receptacle 30.

The sensor arm 20 is the movable portion of the sensor 10. The sensor arm 20 contacts the load 12, so as to be subjected to the displacements of the load 12. More specifically, the sensor arm 20 has an elongated stem portion 21 (i.e., rod) with an elbow portion 22 at an end thereof. The elbow portion 22 has a free connection end 23 thereof received in a bracket 24 of the sensor arm 20 that is secured to the load 12.

Preferably, the free end 23 of the elbow 22 has a ball. Accordingly, the ball forms a ball joint with a receptacle portion of the bracket 24, having a spherical shape. Resilient members are preferably provided such that the ball of the free end 23 is releasably retained within the bracket 24.

The bracket 24 has suitable fasteners so as to be anchored to the load 12. The suitable fasteners depend on the type of load being carried. For instance, adhesives can be used if the load 12 is cardboard boxes. Alternatively, the bracket 24 may be provided with a clamp, tie wrap or similar devices, to be fixed to other shapes, such as a pipe.

According to a preferred embodiment of the present invention, the sensor arm 20 supports a signal generator consisting of four triggers 25 (three of which are visible in FIG. 1), namely an upwardly oriented trigger, a downwardly oriented trigger, and right and left oriented triggers. The triggers 25 are pivotable toward the elongated stem portion 21, but are biased to return to the idle positions illustrated in FIG. 1. The signal generator also has a pair of triggers 26 on the front and back of the sensor arm 20, the triggers 26 being generally radially positioned with respect to the elongated stem portion 21.

The receptacle 30 has a cylindrical hollow receptacle body 31. The cylindrical hollow body 31 has a cylindrical inner surface 32. Opposed ends 33 and 34 of the cylindrical hollow body 31 each have a concentric opening, 35 and 36, respectively.

The sensor arm 20 is held by the joint member 40, so as to have the stem portion 21 superposed with a central axis X of the cylindrical hollow body 31. According to a preferred embodiment of the present invention, the joint member 40 is a conical spring 41. The conical spring 41 is concentrically positioned with respect to the cylindrical hollow body 31. The conical spring 41 has a larger end 42 thereof connected to the end 33, and is positioned about the opening 35 in the cylindrical hollow body 31. The smaller end 43 of the conical spring holds the stem portion 21 of the sensor arm 20, such that stem portion 21 is superposed on the axis X of the cylindrical hollow body 31.

The joint member 40 must allow the pivoting motion of the sensor arm 20 with respect to the receptacle 30. Moreover, the joint member 40 must also allow back and forth movement of the sensor arm 20 along the central axis X of the cylindrical body 31. Various types of joint members may be used for this purpose, but a spring represents a simple and cost effective solution. Moreover, a spring, such as the conical spring 41, biases the sensor arm 20 back to its initial position of FIG. 1, if the free end 23 is separated from the load. Finally, it is preferred to use a conical spring, such as the conical spring 41, as its larger end will allow the sensor arm 20 to move within the receptacle 30.

The cylindrical inner surface 32 defines an abutment surface for the triggers 25. If the sensor arm 20 is displaced beyond a certain value away from the central axis X of the cylindrical body 31, at least one of the triggers 25 will come into contact with the inner surface 32, and will thus generates a signal. Therefore, if the load 12 moves up or down, or left or right, the triggers 25 will signal this movement by coming into contact with the inner surface 32.

The triggers 26 are provided to signal the movement of the sensor arm 20 along the axis X. One of the triggers 26 is provided on a first side of the end 34 of the cylindrical body 31, whereas the other trigger 26 is provided on the second side of the end 34, within the cylindrical body 31. Accordingly, a movement of the sensor arm 20 along the axis X will cause either one of the triggers 26 to be actuated. Therefore, forward and rearward movements of the load 12 are detected.

It is pointed out that other possible configurations for signal generator are contemplated. For instance, the sensor arm 20 may be charged, with contact between the sensor arm 20 and the inner surface 32 closing circuitry to send a signal to the driver. In such a configuration, the inner surface 32 of the receptacle 30 could be provided with segments each representing a direction of displacement of the load, as an alternative to the plurality of triggers 25 and 26.

Referring to FIG. 2, the sensor 10 is shown connected to an interface apparatus 50. Although not illustrated in FIG. 1, wires are provided for every trigger 25 and 26. Preferably, wires pass through a free end of the sensor arm 20 to be connected to the interface apparatus 50. The wires must not interfere with the movement of the sensor arm 20 within the receptacle 30.

Referring to FIG. 2, the interface apparatus 50 is preferably received in the driver/pilot cabin so as to be in the visual or auditive range of the driver/pilot. The interface apparatus 50 must indicate a load displacement to the driver/pilot. In a preferred embodiment of the present invention, the interface apparatus 50 has a microprocessor so as to receive and interpret the signals from the triggers 25 and 26, and convert these signals to an indication of load displacement to the driver/pilot.

According to a preferred embodiment of the present invention, the sensor 10 indicates an orientation and a magnitude of the load displacement. More specifically, each of the triggers 25 and 26 are related to a displacement of the load 12 in a specific direction (i.e., up/down, left/right, and forward/rearward, or combinations of at most three of these directions). Also, the triggers 25 and 26 may provide a magnitude of the load displacement. For instance, a displacement of one of the triggers 25 and 26 from an initial position is quantified in magnitude.

Accordingly, the load displacement may be associated with a value, or with a worded level (e.g., small displacement, large displacement), to provide an idea to the driver/pilot of the importance of the load displacement. For instance, a “small” load displacement may warn the driver/pilot to slow down, and the orientation may add that the slowing down is required in curves. On the other hand, a “large” load displacement may indicate to the driver/pilot that the load should be attended to in view of possible hazards due to the large load displacement.

Returning to FIG. 1, it is seen that the end 34 has a concave shape with respect to an inner cavity of the receptacle 30. According to a preferred embodiment of the present invention, a radius of curvature of the end 34 coincides with a pivot point between the sensor arm 20 and the receptacle 30 (i.e., at the connection between the sensor arm 20 and the joint member 40). This concavity in the end 34 will ensure that any pivoting motion of the sensor arm 20 away from the axis X will not have an effect on the magnitude indicated by the triggers 26.

The free end 23/bracket 24 combination of the sensor arm 20 must be provided with a disconnection indicator. For instance, the outer surface of the free end 23 may be provided with switches that are actuated when the free end 23 is not in an appropriate position within the bracket 24. Advantageously, if the free end 23 inadvertently exits the bracket 24, an indication that the sensor 10 is non-functional can be displayed to the driver/pilot.

Other possible configurations are possible to detect the load movement. For instance, visual detectors may suitably be used to monitor load displacements. However, by connecting the sensor 10 to the load 12, a single sensor is required to monitor load displacements in orientation and magnitude. It is also conceivable that the signals from the sensor 10 be recorded for further use. Alternatively, the interface apparatus 50 could be accessed remotely by wireless equipment.

It is within the ambit of the present invention to cover any obvious modifications of the embodiments described herein, provided such modifications fall within the scope of the appended claims.

1. A sensor for detecting displacement of a load in a freight vehicle, comprising:
a fixed portion adapted to be secured to the freight vehicle in a given position with respect to the load;
a movable portion adapted to be releasably connected to the load so as to be displaced by displacements of the load;
a joint interconnecting the fixed portion to the movable portion so as to allow relative motion between the fixed portion and the movable portion; and
a signal generator connected to any of the fixed portion, the movable portion and the joint so as to detect relative motion between the fixed portion and the movable portion so as to signal a displacement of the load.

2. The sensor according to claim 1, wherein the fixed portion has a cylindrical receptacle, and the movable portion has a rod with the signal generator having a trigger portion on the rod, the movable portion being interconnected to the fixed portion by the joint so as to have the rod concentrically positioned in the cylindrical receptacle, a displacement of a given magnitude of the load causing the trigger portion to contact the cylindrical receptacle so as to signal the displacement of the load.

3. The sensor according to claim 2, wherein the signal generator has a plurality of trigger portions radially positioned on the rod of the movable portion, each of the trigger portions being associated with a direction of displacement of the load, whereby the signal generator signals a direction of the displacement of the load.

4. The sensor according to claim 3, wherein the cylindrical receptacle has a first end to which the joint interconnects the cylindrical portion to the rod, and a second end having a concentric opening through which the rod extends out, the signal generator having a pair of trigger portions on opposed sides of the second end so as to detect axial displacements of the rod with respect to the cylindrical receptacle, the axial displacements being associated to directions of displacement of the load.

5. The sensor according to claim 2, wherein the cylindrical portion has a first end having a concentric opening through which the rod is received in the cylindrical receptacle, the joint being a spring axially aligned with the cylindrical receptacle to maintain the rod concentrically positioned in the cylindrical receptacle.

6. The sensor according to claim 5, wherein the joint is a conical spring.

7. The sensor according to claim 1, wherein the fixed portion is secured to the vehicle by a position-adjustment mechanism so as to be adjustable in position and orientation with respect to the vehicle.

8. The sensor according to claim 7, wherein the position-adjustment mechanism is a telescopic arm.

9. The sensor according to claim 1, wherein the movable portion has a receptacle portion adapted to be connected to the load, and a rod having a connector end connected to the receptacle to as to transmit displacement of the load to the rod.

10. The sensor according to claim 9, further comprising a disconnection controller, and positioned with respect to the movable portion of the sensor so as to detect and signal disengagement between receptacle portion and the connection end of the rod.

11. A method for signaling a displacement of a load in a freight vehicle, comprising the steps of:
providing a sensor positioned with respect to the load such that the sensor is triggered by a displacement of the load with respect to the freight vehicle;
obtaining a signal from the sensor for the displacement; and
sending the signal to a driver of the freight vehicle to indicate that the load has been subjected to a displacement.

12. The method according to claim 11, wherein the signal has information on the direction of movement of the load with respect to the freight vehicle.
